(19) United States
(12) Patent Application Publication
(10) Pub. No.: US 2025/0113409 A1
(43) Pub. Date: Apr. 3, 2025

(54) ADJUSTING COOKING PARAMETERS BASED ON COOKWARE ATTRIBUTES

(71) Applicant: Haier US Appliance Solutions, Inc., Wilmington, DE (US)

(72) Inventor: Eric Scott Johnson, Louisville, KY (US)

(21) Appl. No.: 18/480,059

(22) Filed: Oct. 3, 2023

(51) Int. Cl. H05B 1/02; A47J 36/02; A47J 36/32; F24C 15/32; G06F 3/04847; G06V 10/44; G06V 20/52

(52) U.S. Cl. CPC H05B 1/0261; A47J 36/02; A47J 36/32; F24C 15/322; G06F 3/04847; G06V 10/44; G06V 20/52; H05B 2213/05

(57) ABSTRACT

A cooking appliance includes a cabinet forming a cooking chamber, a plurality of heating elements provided within the cooking chamber, a user interface configured to receive inputs, and a controller operably connected with each of the plurality of heating elements and the user interface, the controller configured to perform an operation. The operation includes receiving one or more inputs to initiate a cooking sequence within the cooking chamber; determining one or more physical attributes of a cookware item to be used in the cooking sequence; adjusting one or more parameters of the cooking sequence in response to determining the one or more physical attributes of the cookware item; and initiating the cooking sequence according to the one or more adjusted parameters.

### FIELD OF THE INVENTION

The present subject matter relates generally to cooking appliances, and more particularly to adjusting heating parameters within an oven appliance based on cookware attributes.

### BACKGROUND OF THE INVENTION

Cooking appliances are used to heat or cook food items to desired temperatures or cooked states. Typically, the items are contained on or within cookware items, such as pots, pans, baking sheets, or the like. Moreover, cooking appliance generally include one or more heating elements configured to supply heat to the cookware items, such as conduction elements, convection elements, radiative elements, induction elements, or the like. For instance, an oven appliance may include a bake element and a broil element.

Certain attributes of the cookware items may influence a cooking operation performed on the food. In some instances, attributes such as size, weight, or color of the cookware item may impact heating patterns that are then transferred to the food items contained on or within the cookware item. Presently, problems exist in tailoring heating operations to account for such discrepancies among different cookware items.

Accordingly, a cooking appliance which obviates one or more of the above-mentioned problems would be beneficial. In particular, a method of operating a cooking appliance to account for different cookware items would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance is provided. The cooking appliance may include a cabinet forming a cooking chamber; a plurality of heating elements provided within the cooking chamber; a user interface configured to receive inputs; and a controller operably connected with each of the plurality of heating elements and the user interface, the controller configured to perform an operation. The operation may include receiving one or more inputs to initiate a cooking sequence within the cooking chamber; determining one or more physical attributes of a cookware item to be used in the cooking sequence; adjusting one or more parameters of the cooking sequence in response to determining the one or more physical attributes of the cookware item, wherein adjusting the one or more parameters of the cooking sequence includes adjusting at least one of a target temperature of the cooking chamber, a relative ratio of power output of the plurality of heating elements, and a duty cycle for each of the plurality of heating elements; and initiating the cooking sequence according to the one or more adjusted parameters.

In another exemplary aspect of the present disclosure, a method of operating a cooking appliance is provided. The cooking appliance may include a cooking chamber and a plurality of heating elements positioned within the cooking chamber. The method may include receiving one or more inputs to initiate a cooking sequence within the cooking chamber; determining one or more physical attributes of a cookware item to be used in the cooking sequence; adjusting one or more parameters of the cooking sequence in response to determining the one or more physical attributes of the cookware item, wherein adjusting the one or more parameters of the cooking sequence includes adjusting at least one of a target temperature of the cooking chamber, a relative ratio of power output of the plurality of heating elements, and a duty cycle for each of the plurality of heating elements; and initiating the cooking sequence according to the one or more adjusted parameters.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an oven range according to exemplary embodiments of the present disclosure.

FIG. 2 provides a side cut-away view of the exemplary oven range of FIG. 1.

FIG. 3 provides a schematic representation of a display of the exemplary cooking appliance of FIG. 1.

FIG. 4 provides a flow chart illustrating a method of operating a cooking appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

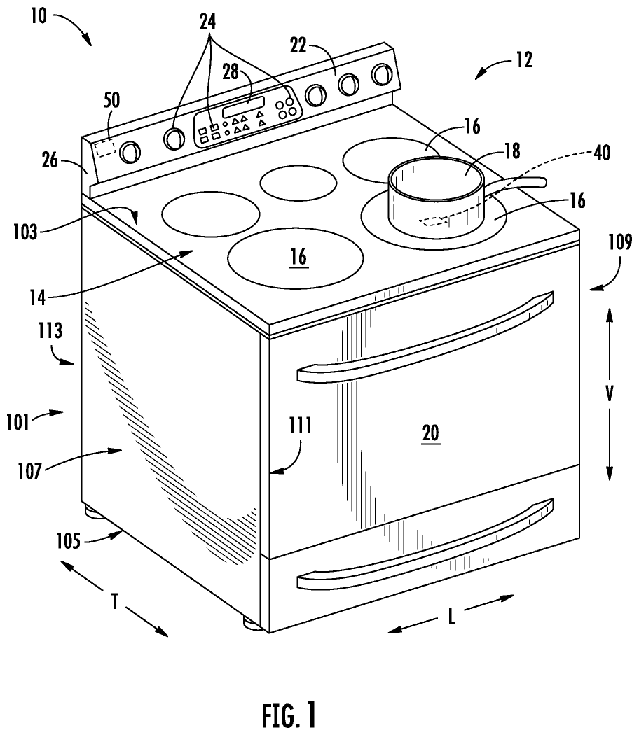

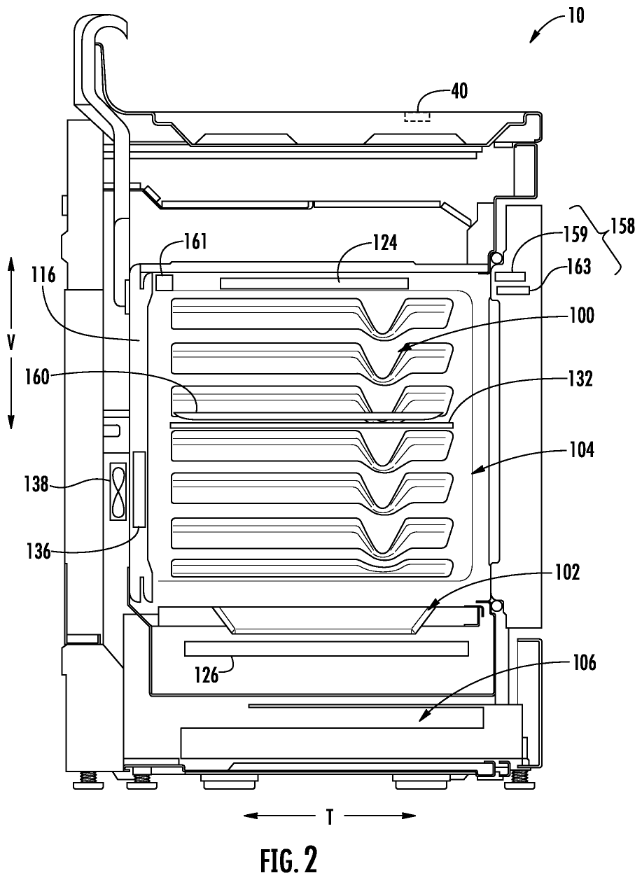

FIG. 1 provides a perspective view of a cooking appliance, or oven range 10, including a cooktop 12, and FIG. 2 provides a side cut-away view of the cooking appliance 10. Cooking appliance 10 is provided by way of example only and is not intended to limit the present subject matter to the arrangement shown in FIGS. 1 and 2. Thus, the present subject matter may be used with other range 10 and/or cooktop 12 configurations, e.g., double oven range appliances. As illustrated, cooking appliance 10 generally defines a vertical direction V, a lateral direction L, and a transverse direction T, each of which is mutually perpendicular, such that an orthogonal coordinate system is generally defined. Cooking appliance 10 may include a cabinet 101 that extends between a top 103 and a bottom 105 along the vertical direction V, between a left side 107 and a right side 109 along the lateral direction, and between a front 111 and a rear 113 along the transverse direction T.

A cooking surface 14 of cooktop 12 may include a plurality of heating elements 16. For the embodiment depicted, cooktop 12 includes five heating elements 16 spaced along cooking surface 14. Heating elements 16 may be electric heating elements and are positioned at, e.g., on or proximate to, the cooking surface 14. In certain exemplary embodiments, cooktop 12 is a radiant cooktop with resistive heating elements or coils mounted below cooking surface 14. However, in other embodiments, the cooktop appliance 12 includes other suitable shape, configuration, and/or number of heating elements 16, for example, cooktop 12 may be an open coil cooktop with heating elements 16 positioned on or above surface 14. Additionally or alternatively, in other embodiments, cooktop 12 may include any other suitable type of heating element 16, such as an induction heating element. Each of the heating elements 16 may be the same type of heating element 16, or cooktop 12 may include a combination of different types of heating elements 16.

As shown in FIG. 1, a cooking utensil (or cookware item) 18, such as a pot, pan, or the like, may be placed on a heating element 16 to heat the cookware item 18 and cook or heat food items placed within cookware item 18. Cooking appliance 10 may also include a door 20 that permits access to a cooking chamber 104 of oven range 10, e.g., for cooking or baking of food items therein. A control panel 22 having controls (e.g., a user interface or user interface assembly) 24 may permit a user to make selections for cooking of food items. Although shown on a backsplash or back panel 26 of oven range 10, control panel 22 may be positioned in any suitable location.

Controls 24 may include buttons, knobs, and the like, as well as combinations thereof, and/or controls 24 may be implemented on a remote user interface device such as a smartphone. As an example, a user may manipulate one or more controls 24 to select a temperature and/or a heat or power output for each heating element 16 and the cooking chamber 104. The selected temperature or heat output of heating element 16 affects the heat transferred to cookware item 18 placed on heating element 16. A display 28 may be provided (e.g., on or in control panel 22). Display 28 may display information regarding cooking operations or inputs from a user regarding the cooking operation. Display 28 may be any suitable display capable of providing visual feedback, such as a liquid crystal display (LCD), a light emitting diode (LED) display, a segmented display, or the like. Additionally or alternatively, display 28 may be a touch display capable of receiving touch inputs from a user.

Cooktop appliance 12 may further include or be in operative communication with a processing device or a controller 50 that may be generally configured to facilitate appliance operation. In this regard, control panel 22, controls 24, and display 28 may be in communication with controller 50 such that controller 50 may receive control inputs from controls 24, may display information using display 28, and may otherwise regulate operation of cooking appliance 10. For example, signals generated by controller 50 may operate cooking appliance 10, including any or all system components, subsystems, or interconnected devices, in response to the position of controls 24 and other control commands. Control panel 22 and other components of appliance 10 may be in communication with controller 50 via, for example, one or more signal lines or shared communication busses. In this manner, Input/Output (“I/O”) signals may be routed between controller 50 and various operational components of appliance 10.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 50 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 50 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 50 may be operable to execute programming instructions or micro-control code associated with an operating cycle of cooking appliance 10. In this regard, the instructions may be software or any set of instructions that when executed by the processing device, cause the processing device to perform operations, such as running one or more software applications, displaying a user interface, receiving user input, processing user input, etc. Moreover, it should be noted that controller 50 as disclosed herein is capable of and may be operable to perform any methods, method steps, or portions of methods as disclosed herein. For example, in some embodiments, methods disclosed herein may be embodied in programming instructions stored in the memory and executed by controller 50.

The memory devices may also store data that can be retrieved, manipulated, created, or stored by the one or more processors or portions of controller 50. The data can include, for instance, data to facilitate performance of methods described herein. The data can be stored locally (e.g., on controller 50) in one or more databases and/or may be split up so that the data is stored in multiple locations. In addition, or alternatively, the one or more database(s) can be connected to controller 50 through any suitable network(s), such as through a high bandwidth local area network (LAN) or wide area network (WAN). In this regard, for example, controller 50 may further include a communication module or interface that may be used to communicate with one or more other component(s) of appliance 10, controller 50, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Cooking appliance 10 may include a sensor 40. Sensor 40 may be integrally formed with cooking appliance 10 (e.g., within cooktop 12, within cooking chamber 104, etc.). In some embodiments, sensor 40 is operably connected to cooking appliance 10 (e.g., via a port or socket, via a remote connection, etc.). Sensor 40 may monitor a temperature of cookware item 18 or a food item provided within cookware item 18. Accordingly, temperature sensor 40 may deliver signals (e.g., voltage signals) representing the temperature of cookware item 18 to controller 50. The signals may be sent according to a predetermined frequency (e.g., at predetermined time intervals). Thus, controller 50 may analyze a temperature or temperature change of cookware item 18.

Sensor 40 may be configured to determine a material composition of cookware item 18. For instance, as mentioned above, heating element 16 may be an induction heating element. Accordingly, induction heating element 16 may generate a magnetic field to excite or energize certain cookware items, causing the cookware item 18 to heat up. Induction heating element 16 may thus include sensor 40 to determine whether the cookware item 18 includes a ferrous or magnetic material (e.g., containing a significant amount of iron). For at least one example, sensor 40 detects whether cookware item 18 reacts to the magnetic field created by induction heating element 16.

Further, one or more heating elements may be provided at the top, bottom, or both of cooking chamber 104, and may provide heat to cooking chamber 104 for cooking. Such heating element(s) can be gas, electric, microwave, or a combination thereof. For example, in the embodiment shown in FIG. 2, cooking appliance 10 includes a top heating element 124 positioned at a top of cooking chamber 104 and a bottom heating element 126 positioned at a bottom of cooking chamber 104. Other configurations may be used as well. For instance, multiple top heating elements 124 and multiple bottom heating elements 126 may be incorporated.

Cooking appliance 10 may also have a convection heating element 136 and/or convection fan 138 (e.g., collectively a convection heating assembly) positioned adjacent a back wall 116 of cooking chamber 104. Convection fan 138 may be powered by a convection fan motor. Further, convection fan 138 may be a variable speed fan-meaning the speed of fan 138 may be controlled or set anywhere between and including, e.g., zero and one hundred percent (0%-100%). According to at least one example, convection fan 138 is provided as a stand-alone fan (e.g., without an accompanying convection heating element). In certain embodiments, cooking appliance 10 also includes a bidirectional triode thyristor (not shown), i.e., a triode for alternating current (TRIAC), to regulate the operation of convection fan 138 such that the speed of fan 138 may be adjusted during operation of cooking appliance 10. The speed of convection fan 138 may be determined by controller 50. In addition, a sensor such as, e.g., a rotary encoder, a Hall effect sensor, or the like, may be included at the base of fan 138 to sense the speed of fan 138.

The speed of fan 138 may be measured in, e.g., revolutions per minute (“RPM”). In some embodiments, the convection fan 138 may be configured to rotate in two directions, e.g., a first direction of rotation and a second direction of rotation opposing the first direction of rotation (see FIG. 6). For example, in some embodiments, reversing the direction of rotation, e.g., from the first direction to the second direction or vice versa, may still direct air from the back of cooking chamber 14. As another example, in some embodiments reversing the direction results in air being directed from the top and/or sides of cooking chamber 14 rather than the back of cooking chamber 14. Additionally or alternatively, an effective speed for convection fan 138 may be determined. The effective speed of fan 138 may include adjusting a rotational speed of the fan. Moreover, the effective speed may relate to a duty cycle of fan 138. For instance, an effective speed of fan 138 may incorporate a determined cycle of “ON’ and “OFF” times (e.g., in addition to or apart from the rotational speed).

In various embodiments, more than one convection heater assembly, e.g., more than one convection heating element 136 and/or convection fan 138 may be provided. In such embodiments, the number of convection fans and convection heaters may be the same or may differ, e.g., more than one convection heating element 136 may be associated with a single convection fan 138. Similarly, top heating elements and/or bottom heating elements may be provided in various combinations, e.g., one top heating element with two or more bottom heating elements, two or more top heating elements 124, 126 with no bottom heating element, etc.

Oven appliance 10 may include supports (FIG. 2) for supporting oven racks 132 (FIG. 2) that may be selectively positioned within cooking chamber 104. Oven racks 132 include a top rack and a bottom rack. The top rack may be positioned above the bottom rack along the vertical direction V, as would be understood. Oven racks 132 may be adjusted within cooking chamber 104. For instance, oven rack 132 may be placed higher or lower within cooking chamber 104 as a user sees fit, or as may be required for specific applications.

FIG. 2 provides an exemplary schematic view of cooking chamber 104 containing a cookware item 160. As shown, the cookware item 160 provided within cooking chamber 104 may have a predetermined size. For instance, cookware item 160 may occupy a certain percentage of oven rack 132 on which it is supported. This in turn may affect an amount of heat (e.g., heat energy) is absorbed by cookware item 160 and transferred to the contents of cookware item 160. Additionally or alternatively, cookware item 160 may have a unique finish exhibiting a number of specific attributes (e.g., color, reflectivity or emissivity, texture, shade, etc.). For at least one example, cookware with a lighter color or shade (e.g., silver, white, mirrored, etc.) may reflect more heat or thermal energy (e.g., toward other cooking zones) and absorb less heat or thermal energy. Accordingly, cookware with a darker color or shade (e.g., black, brown, matte, etc.) may absorb more heat or thermal energy. As will be described below, certain operations may be adjusted according to the cookware attributes.

One or more sensors 158 may be provided within cooking chamber 104. For instance, sensors 158 may be provided within door 20 of appliance 10 (e.g., facing cooking chamber 104). The one or more sensors 158 may include, for instance, an image capture device (or camera) 159. However, the one or more sensors 158 may include, in addition to or alternatively from the camera, an ultrasonic sensor, an infrared sensor, an optical sensor, or the like. Hereinafter, the one or more sensors 158 will be described with specific reference to a camera (e.g., camera 159). It should be understood that the information or data collected by camera 159 may be obtained through any suitable sensor, such as the aforementioned ultrasonic sensor or optical sensor. Additionally or alternatively, camera 159 may be positioned outside of cooking chamber 104. For instance, camera 159 may be positioned above cooking surface 14 (e.g., as part of an over-the-range or OTR microwave). Further still, camera 159 may be a mobile camera, such as a camera imbedded within a mobile device (e.g., smartphone).

Generally, camera 159 may be a video camera or a digital camera with an electronic image sensor [e.g., a charge coupled device (CCD) or a CMOS sensor]. When assembled, camera 159 is in communication (e.g., electric or wireless communication) with controller 50 such that controller 50 may receive a signal from camera 159 corresponding to the image captured by camera 159. Camera 159 may be configured to capture images of cooking chamber 104. For instance, camera 159 may capture images of cookware item 160. Camera 159 may be located at or near a top of cooking chamber 14 along the vertical direction V. Additionally or alternatively, camera 159 may be located at or near a center of cooking chamber 104 along the lateral direction L. The specific location of camera 159 is not limited, however, and one of ordinary skill in the art would appreciate multiple potential locations for camera 159.

The image or images captured by camera 159 may be analyzed (e.g., within controller 50) to determine one or more attributes of cookware item 160 within cooking chamber 104. For instance, camera 159 may capture an image of cookware item 160 (e.g., roasting pan, baking dish, cookie sheet, etc.). The image may be analyzed to determine certain features of cookware item 160. For instance, the analysis may determine a material, an emissivity, a surface texture, a color, a size, a shape, or the like of the cookware item. Such features may selectively alter a heating rate of the items (e.g., food items) within cooking chamber 104. For instance, the attributes of cookware item 160 may affect thermal energy transfer from cookware item 160 to a food item positioned on or within cookware item 160.

The one or more sensors may additionally include a temperature sensor 161. For instance, a single temperature sensor 161 may be provided within cooking chamber 104. Temperature sensor 161 may be positioned, for example, on a back wall, upper wall, or side wall of cooking chamber 104 or within door 20 of appliance 10. Temperature sensor 161 may sense (e.g., selectively, continuously) a temperature within cooking chamber 104 (e.g., at predetermined intervals). Additionally or alternatively, temperature sensor 161 may transmit the sensed temperatures to controller 50.

As used herein, “temperature sensor” or the equivalent is intended to refer to any suitable type of temperature measuring system or device positioned at any suitable location for measuring the desired temperature. Thus, for example, the temperature sensor may be any suitable type of temperature sensor, such as a thermistor, a thermocouple, a resistance temperature detector, a semiconductor-based integrated circuit temperature sensors, etc. In addition, the temperature sensor may be positioned at any suitable location and may output a signal, such as a voltage, to a controller that is proportional to and/or indicative of the temperature being measured. Although exemplary positioning of temperature sensors is described herein, it should be appreciated that appliance 10 may include any other suitable number, type, and position of temperature, humidity, and/or other sensors according to alternative embodiments.

The one or more sensors 158 may include an infrared (IR) sensor 163. IR sensor 163 may be any suitable type of infrared sensor configured to detect or sense a temperature level of the surrounding surfaces proximate IR sensor 163. For example, IR sensor 163 may be an active or passive infrared sensor. IR sensor 163 may be mounted to or within cooking chamber 104.

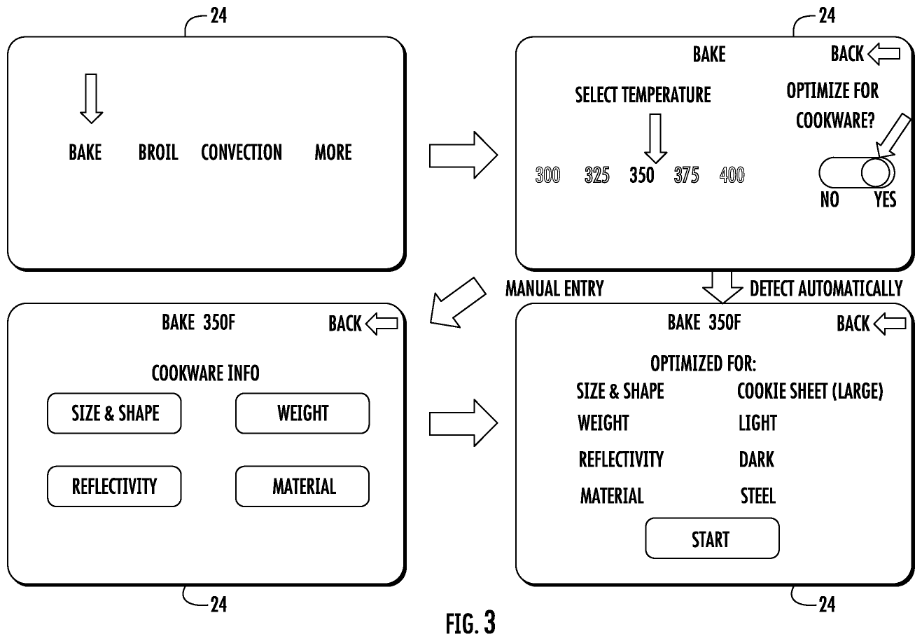

Referring now to FIG. 3, an exemplary selection process for initiating a cooking operation will be described. In detail, the user may select one of a plurality of cooking methods (e.g., a bake method, a broil method, a convection method, etc.). User interface 24 may present the user with an option to select the desired method, for instance, “Bake” as shown in FIG. 3. The user may then select a desired temperature at which to perform the cooking operation. While selecting the temperature, user interface 24 may present an option to optimize the cooking operation for a specific cookware item (e.g., “Optimize For Cookware”).

Upon selecting “Yes” to optimize for cookware item 160, the process may present the user an option to select one or more features (e.g., physical features or attributes) pertaining to the cookware item to be used. According to some embodiments, cooking appliance 10 (e.g., via controller 50 through one or more sensors) may automatically detect one or more features pertaining to the cookware item. As mentioned above, the one or more physical attributes may include a size (e.g., surface area dimensions), a shape, a weight, a reflectivity or emissivity, a material composition, or the like. Thus, via user interface 24, the user may select (e.g., from a list or via manual entry) one or more particular physical attributes. Upon selecting the physical attributes, user interface 24 may present an option to start or initiate the cooking operation.

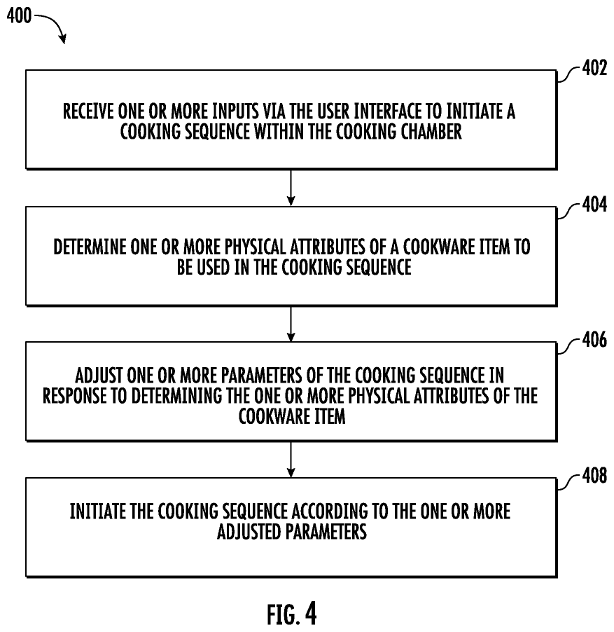

Now that the general descriptions of an exemplary appliance have been described in detail, a method 400 of operating an appliance (e.g., cooking appliance 10) will be described in detail. Although the discussion below refers to the exemplary method 400 of operating cooking appliance 10, one skilled in the art will appreciate that the exemplary method 400 is applicable to any suitable domestic appliance capable of performing a cooking operation (e.g., such as a stand-alone oven, etc.). In exemplary embodiments, the various method steps as disclosed herein may be performed by controller 50 and/or a separate, dedicated controller. FIG. 4 provides a flow chart illustrating a method of operating a cooking appliance. Hereinafter, method 400 will be described with specific reference to FIG. 4.

At step 402, method 400 may include receiving one or more inputs to initiate a cooking sequence (or operation) within the cooking chamber. In detail, a user may provide an input (e.g., via a user input) to a cooking appliance (e.g., cooking appliance 10) to perform a specific cooking operation including a cookware item (e.g., cookware item 160). The one or more inputs may include a cooking method (e.g., bake, broil, convection cook, etc.), a temperature (e.g., desired cooking temperature), a cooking time, or the like.

At step 404, method 400 may include determining one or more physical attributes of a cookware item to be used in the cooking sequence. As mentioned above, the cooking sequence or operation may be performed within a cooking chamber (e.g., cooking chamber 104) such as an oven chamber. Thus, the cooking sequence may include use of a cookware item, such as a cookie sheet or baking sheet. Prior to initiating the cooking sequence, the method may obtain one or a set of physical attributes of the cookware item,

According to one embodiments, the one or more physical attributes may be obtained by receiving an input via the user interface. For instance, as discussed above with respect to FIG. 3, the user interface may prompt the user to enter or select the one or more physical attributes. In turn, the user may select a reflectivity (e.g., emissivity or shininess) of the cookware item. In some embodiments, the user interface presents a plurality of options from which to choose the reflectivity (e.g., highly reflective, matte, dull, dark, etc.).

The user may additionally or alternatively select a size of the cookware item. For instance, the appliance may include a plurality of predetermined sizes (e.g., surface area sizes) of cookware items. The list of predetermined sizes may be presented to the user for selection. Moreover, the user may select a prompt to manually input a custom size of the cookware item. The user may additionally or alternatively select a shape of the cookware item. For instance, the shape may be presented together along with the size (e.g., 18″×13″ rectangle, 9.5″×13″ rectangle, etc.). A plurality of shapes may be presented to the user for selection. Moreover, the user may select a prompt to manually input a shape of the cookware item.

The user may additionally or alternatively select a weight of the cookware item. For instance, the appliance may include a plurality of predetermined weights of common cookware items (e.g., light, medium, medium heavy, heavy, etc.). The list of predetermined weights may be presented to the user for selection. Moreover, the user may select a prompt to manually input a weight of the cookware item. The user may additionally or alternatively select a material composition of the cookware item. For instance, the appliance may include a plurality of predetermined materials of cookware items. The list of predetermined materials may be presented to the user for selection. Moreover, the user may select a prompt to manually input a material of the cookware item.

In additional or alternative embodiments, in determining the one or more physical attributes of the cookware item, method 400 may incorporate a sensor (e.g., sensor 40). As described above, the sensor may be an induction sensor configured for determining or confirming a material composition of the cookware item. The sensor may be incorporated into a heating element (e.g., induction heating element 16) on a cooktop portion of the cooking appliance. Thus, the user may position the cookware item on top of the induction heating element and activate the induction heating element. In some embodiments, the induction heating element is activated according to a detection mode. Thus, the induction heating element may be initiated according to a predetermined cycle or manner to detect a ferrous composition of the cookware item. Additionally or alternatively, the sensor may be a weight sensor (e.g., a scale). The cookware item may be positioned on the scale, whereby the cookware item weight (or mass) may be determined. It should be appreciated that one or all of the above-mentioned sensors may be incorporated into specific embodiments.

In additional or alternative embodiments, in determining the one or more physical attributes of the cookware item, method 400 may incorporate one or more sensors provided within the cooking chamber. As described above, the cooking appliance may include an image capture device positioned within the cooking chamber (or positioned so as to capture images of items provided within the cooking chamber). Accordingly, after receiving the one or more inputs to initiate the cooking sequence, the image capture device (e.g., camera) may be driven to capture an image of the interior of the cooking chamber. The image may contain the cookware item. The image may then be transmitted to a controller (e.g., controller 50) for image analysis.

Method 400, at step 404, may thus analyze the captured image. The image analysis may incorporate a neural network classification module and/or a machine learning image recognition process. In this regard, for example, the controller may be programmed to implement the machine learning image recognition process that includes a neural network trained with a plurality of images of various cookware items, cookware items containing food, etc. By analyzing the image(s) captured using this machine learning image recognition process, the controller may properly evaluate the one or more characteristics of the cookware item, e.g., by identifying the trained image that is closest to the obtained image.

As used herein, the terms image recognition process and similar terms may be used generally to refer to any suitable method of observation, analysis, image decomposition, feature extraction, image classification, etc. of one or more images or videos taken within a cooking appliance. In this regard, the image recognition process may use any suitable artificial intelligence (AI) technique, for example, any suitable machine learning technique, or for example, any suitable deep learning technique. It should be appreciated that any suitable image recognition software or process may be used to analyze images taken by the camera and the controller may be programmed to perform such processes. Thus, in determining the one or more physical attributes of the cookware item, method 400 may extract the one or more physical attributes from the analysis of the captured image (e.g., using the image recognition process).

At step 406, method 400 may include adjusting one or more parameters of the cooking sequence in response to determining the one or more physical attributes of the cookware item. In detail, method 400 may analyze the one or more physical attributes and determine heating parameters for the heating elements within the cooking chamber. For instance, the heating parameters may include (e.g., for a preheat or cooking phase of the cooking sequence) a target temperature, a relative ratio of heat from each of the plurality of heating elements, a duty cycle for each of the plurality of heating elements, a convection fan duty cycle, a convection fan rotational direction or speed, or the like. Thus, food heated within the particular cookware-specific heating parameters may be similar between two different pieces of cookware as compared to using a single unadjusted set of heating parameters for each cookware item.

For one example, at step 406, method 400 may determine that more heat is required from a top heating element (e.g., top heating element 124) than from a bottom heating element. Accordingly, a set of default parameters for each of the top heating element and the bottom heating element are adjusted such that more power is supplied to the top heating element than the bottom heating element. For another example, method 400 may determine that a higher convection rate is required to maintain an even temperature across the cookware item. Accordingly, the default parameters may be adjusted to drive a convection heating element (e.g., convection heating element 136) and/or a convection fan (e.g., convection fan 138) at a higher rate or power level. As discussed above, additional or alternative adjustments may be incorporated. For instance, particular duty cycles for each of the top heating element and the bottom heating element may be defined or set. Thus, each of the top heating element and the bottom heating element may be individually cycled to provide heat to different portions (e.g., a top or bottom) of the cookware item. Thus, method 400 may include generating a heating profile for the cookware item based on the one or more extracted physical attributes. The heating profile may include each of the adjusted parameters of the cooking sequence, including the adjusted power level ratios, duty cycles, and target temperatures for the cookware item. Moreover, a different heating profile may be generated for each individual cookware item.

Method 400 may include storing the heating profile within a memory of the appliance. For instance, the generated heating profile or heating profiles may be stored onboard the appliance (e.g., within the controller thereof). The cookware item may be identified by a particular tag, photo identification, or the like. The adjusted heating parameters for the cookware item may thus be easily retrieved in subsequent cooking sequences. The stored heating profile may be presented to the user (e.g., at or after step 402 described above) in subsequent heating sequences. Additionally or alternatively, the stored heating profiles may be retrieved upon photo identification. For instance, the cookware item may be recognized via a photo capture in a subsequent cooking sequence (e.g., via the image capture device).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance comprising:
a cabinet forming a cooking chamber;
a plurality of heating elements provided within the cooking chamber;
a user interface configured to receive inputs; and
a controller operably connected with each of the plurality of heating elements and the user interface, the controller configured to perform an operation, the operation comprising:
receiving one or more inputs to initiate a cooking sequence within the cooking chamber;
determining one or more physical attributes of a cookware item to be used in the cooking sequence;
adjusting one or more parameters of the cooking sequence in response to determining the one or more physical attributes of the cookware item, wherein adjusting the one or more parameters of the cooking sequence comprises adjusting at least one of a target temperature of the cooking chamber, a relative ratio of power output of the plurality of heating elements, and a duty cycle for each of the plurality of heating elements; and
initiating the cooking sequence according to the one or more adjusted parameters.

2. The cooking appliance of claim 1, wherein determining the one or more physical attributes of the cookware item comprises:
receiving an input via the user interface regarding at least one of an emissivity of the cookware item, a color of the cookware item, a surface area size of the cookware item, a shape of the cookware item, a material composition of the cookware item, or a weight of the cookware item.

3. The cooking appliance of claim 1, further comprising:
a cooktop positioned above the cooking chamber; and
a sensor provided within the cooktop, wherein the sensor is configured to determine a ferrous composition of the cookware item.

4. The cooking appliance of claim 3, wherein determining the one or more physical attributes of the cookware item comprises:
receiving a signal from the sensor, the signal identifying the cookware item as comprising a ferrous material.

5. The cooking appliance of claim 1, wherein the plurality of heating elements comprises:
a bake heating element positioned at a bottom of the cooking chamber; and
a broil heating element positioned at a top of the cooking chamber.

6. The cooking appliance of claim 1, wherein the plurality of heating elements comprises:
a convection heating element positioned at a rear of the cooking chamber; and
a convection fan positioned adjacent to the convection heating element, and wherein adjusting the one or more parameters of the cooking sequence further comprises:
adjusting at least one of a duty cycle of the convection fan, a rotational direction of the convection fan, or a rotational speed of the convection fan.

7. The cooking appliance of claim 1, further comprising:
an image capture device configured to capture one or more images of the cookware item.

8. The cooking appliance of claim 7, wherein determining the one or more physical attributes of the cookware item comprises:
capturing an image of the cookware item via the image capture device;
analyzing the captured image; and
extracting the one or more physical attributes from the analysis of the captured image.

9. The cooking appliance of claim 8, wherein the operation further comprises:
generating a heating profile for the cookware item based on the one or more extracted physical attributes; and
storing the heating profile within a memory of the controller.

10. A method of operating a cooking appliance, the cooking appliance comprising a cooking chamber and a plurality of heating elements positioned within the cooking chamber, the method comprising:
receiving one or more inputs to initiate a cooking sequence within the cooking chamber;
determining one or more physical attributes of a cookware item to be used in the cooking sequence;
adjusting one or more parameters of the cooking sequence in response to determining the one or more physical attributes of the cookware item, wherein adjusting the one or more parameters of the cooking sequence comprises adjusting at least one of a target temperature of the cooking chamber, a relative ratio of power output of the plurality of heating elements, and a duty cycle for each of the plurality of heating elements; and
initiating the cooking sequence according to the one or more adjusted parameters.

11. The method of claim 10, wherein determining the one or more physical attributes of the cookware item comprises:
receiving an input via a user interface regarding at least one of an emissivity of the cookware item, a surface area size of the cookware item, a material composition of the cookware item, or a weight of the cookware item.

12. The method of claim 10, wherein the cooking appliance further comprises:
a cooktop positioned above the cooking chamber; and
a sensor provided within the cooktop, wherein the sensor is configured to determine a ferrous composition of the cookware item.

13. The method of claim 12, wherein determining the one or more physical attributes of the cookware item comprises:
receiving a signal from the sensor, the signal identifying the cookware item as comprising a ferrous material.

14. The method of claim 10, wherein the plurality of heating elements comprises:
a bake heating element positioned at a bottom of the cooking chamber; and
a broil heating element positioned at a top of the cooking chamber.

15. The method of claim 10, wherein the plurality of heating elements comprises:
a convection heating element positioned at a rear of the cooking chamber; and
a convection fan positioned adjacent to the convection heating element, and wherein adjusting the one or more parameters of the cooking sequence further comprises:
adjusting at least one of a duty cycle of the convection fan, a rotational direction of the convection fan, or a rotational speed of the convection fan.

16. The method of claim 10, wherein the cooking appliance further comprises:
an image capture device configured to capture one or more images of the cookware item.

17. The method of claim 16, wherein determining the one or more physical attributes of the cookware item comprises:
capturing an image of the cookware item via the image capture device;
analyzing the captured image; and
extracting the one or more physical attributes from the analysis of the captured image.

18. The method of claim 17, further comprising:
generating a heating profile for the cookware item based on the one or more extracted physical attributes; and
storing the heating profile within a memory of the cooking appliance.
